(19) United States
(12) Patent Application Publication
(10) Pub. No.: US 2026/0267201 A1
(43) Pub. Date: Sep. 10, 2026

(54) OPTICAL APPARATUS AND IMAGE PICKUP SYSTEM

(71) Applicant: CANON KABUSHIKI KAISHA, Tokyo (JP)

(72) Inventors: Daisuke SHIRAISHI, Tochigi (JP); Kazuhiro NOGUCHI, Tochigi (JP)

(21) Appl. No.: 19/665,077

(22) Filed: May 1, 2026

Related U.S. Application Data
(63) Continuation of application No. PCT/JP2024/029550, filed on Aug. 21, 2024.

(30) Foreign Application Priority Data
Nov. 14, 2023 (JP) 2023-193912
Mar. 12, 2024 (JP) 2024-038179

(51) Int. Cl. G03B 5/00; G03B 17/14

(52) U.S. Cl. CPC G03B 5/00; G03B 17/14; G03B 2205/0069

(57) ABSTRACT

An optical apparatus includes a movable member, and two or more motors each including a first coil, a second coil, and a magnet assembly. Each of the first coil and the second coil is configured to generate a driving force to the movable member in a direction parallel to an optical axis. The magnet assembly has a Halbach array. At least one of the first coil and the second coil includes a bent portion. When a number of the motors is N, the two or more motors are arranged at intervals of 360/N degrees along a circumferential direction about the optical axis.

### CROSS-REFERENCE TO RELATED APPLICATIONS

This application is a Continuation of International Patent Application No. PCT/JP2024/029550, filed on August 21, 2024, which claims the benefit of Japanese Patent Application Nos. 2023-193912, filed on November 14, 2023, and 2024-038179, filed on March 12, 2024, each of which is hereby incorporated by reference herein in their entirety.

### BACKGROUND

### Field of the Technology

The present disclosure relates to an optical apparatus and an image pickup system.

### DESCRIPTION OF THE RELATED ART

PCT International Publication No. WO 2019/234980 discloses a linear motor that includes a plurality of magnets and a plurality of coils and is configured to drive a lens barrel that holds an optical system for changing a focal length or performing focusing of an interchangeable camera lens.

PCT International Publication No. WO 2017/169908 discloses a linear motor in which magnet assemblies in a Halbach array are disposed on both sides of a plurality of coils to drive the motor.

### SUMMARY

An optical apparatus according to one aspect of the present disclosure includes a movable member, and two or more motors each including a first coil, a second coil, and a magnet assembly. Each of the first coil and the second coil is configured to generate a driving force to the movable member in a direction parallel to an optical axis. The magnet assembly has a Halbach array. At least one of the first coil and the second coil includes a bent portion. When a number of the motors is N, the two or more motors are arranged at intervals of 360/N degrees along a circumferential direction about the optical axis.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram of an image pickup system including an interchangeable lens according to an embodiment of the present disclosure.

FIG. 2 is an exploded perspective view of a focus unit according to a first embodiment.

FIG. 3 is an X-Z cross-sectional view of the focus unit according to the first embodiment.

FIG. 4 is an X-Y cross-sectional view of the focus unit according to the first embodiment.

FIGS. 5A and 5B are explanatory diagrams of an A-phase coil according to the first embodiment.

FIG. 6 is a perspective view of a lens barrel and peripheral components according to the first embodiment.

FIG. 7 is a side view of a magnet assembly and a magnet holding plate according to the first embodiment.

FIGS. 8A, 8B and 8C are X-Y cross-sectional views of a linear motor according to the first embodiment.

FIG. 9 is a diagram illustrating temporal changes of the currents supplied to an A-phase coil and a B-phase coil according to the first embodiment.

FIG. 10 is an X-Y cross-sectional view illustrating main components of the focus unit according to the first embodiment.

FIG. 11 is a perspective view illustrating only some components of a focus unit according to a second embodiment.

FIG. 12 is a front view of the focus unit according to the second embodiment when viewed from a negative X-axis direction.

FIG. 13 is a perspective view of an A-phase coil according to the second embodiment.

FIGS. 14A and 14B are diagrams illustrating a case where the conventional configuration is applied to a lens driving apparatus.

### DESCRIPTION OF THE EMBODIMENTS

In order to drive a lens barrel having a large mass using the linear motor disclosed in PCT International Publication No. WO 2019/234980, magnets and yokes may be enlarged, which may cause an increase in size of the interchangeable lens.

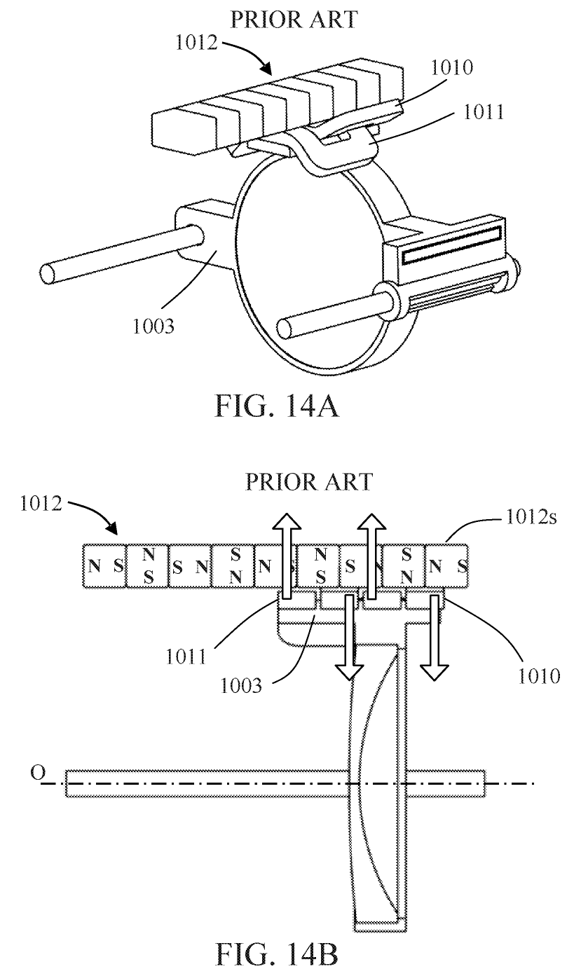

In a case where the linear motor disclosed in PCT International Publication No. WO 2017/169908 is used to drive a lens barrel, a configuration may be considered in which the lens barrel holds the coils and magnet assemblies are disposed on both sides of it. In this case, however, the interchangeable lens increases in size in a radial direction. A description will now be given of a case in which, as illustrated in FIG. 14A, two-phase coils 1010 and 1011 are fixed to a lens barrel 1003, and a magnet assembly 1012 in a Halbach array is disposed on one side. In this case, as illustrated in FIG. 14B, the magnetic flux in a driving direction generated by a sub-magnet 1012s of the magnet assembly 1012 and the currents flowing through the coils 1010 and 1011 (in a paper plane direction) generate a Lorentz force in a direction orthogonal to an optical axis O (arrow direction). As a result, the moment acts on the lens barrel 1003, and the lens barrel 1003 tilts, which may degrade optical performance. In addition, when such a linear motor is used, an amplitude of current flowing through the coils 1010 and 1011 periodically increases and decreases, and thus the magnitude of the Lorentz force also periodically changes. As a result, the lens barrel 1003 vibrates and noise is generated, which may degrade moving image capturing performance.

Referring now to the accompanying drawings, a detailed description will be given of embodiments according to the present disclosure. Corresponding elements in respective figures will be designated by the same reference numerals, and a duplicate description thereof will be omitted.

### CONFIGURATION OF INTERCHANGEABLE LENS

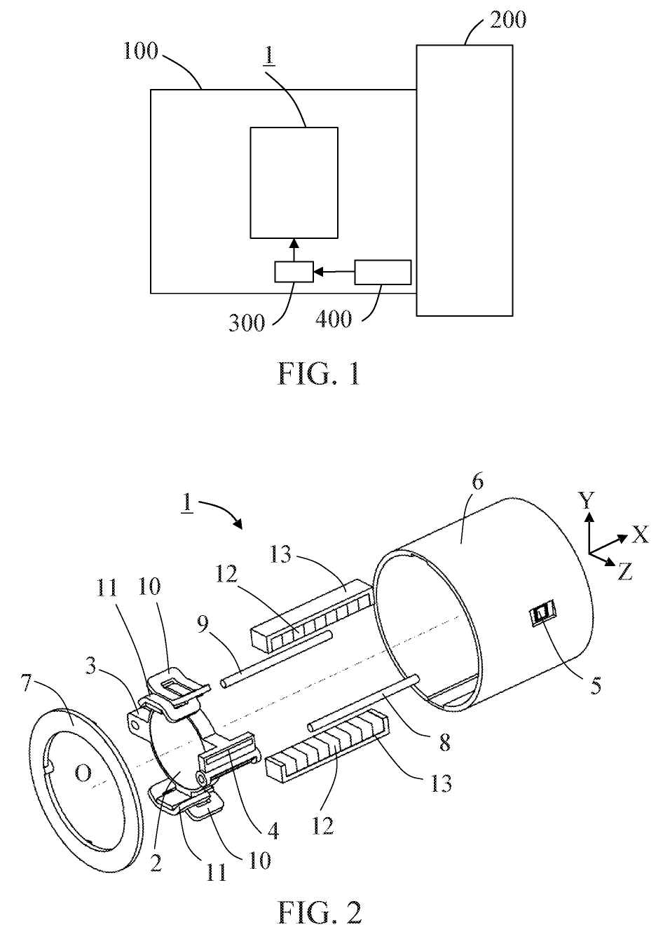

FIG. 1 is a schematic diagram of an image pickup system including an interchangeable lens (an optical apparatus) 100 according to an embodiment of the present disclosure. The interchangeable lens 100 is mechanically and electrically connected to a camera body (an image pickup apparatus) 200 by a mount (not illustrated). The interchangeable lens 100 is detachably attachable to the camera body 200. The interchangeable lens 100 includes a focus unit 1 configured to perform focusing, a driving circuit 300 configured to drive a linear motor 500 described later, and a lens control unit 400 configured to control driving of the linear motor 500 and other components in the interchangeable lens 100. The interchangeable lens 100 further includes a zoom optical system, a aperture stop unit configured to adjust a light amount, operation members, and the like, which are omitted for simple description. In the present embodiment, the focus unit 1 for focusing will be described as an example of a lens driving apparatus, but a unit configured to drive a lens for changing a focal length may also be used.

### FIRST EMBODIMENT

### CONFIGURATION OF FOCUS UNIT

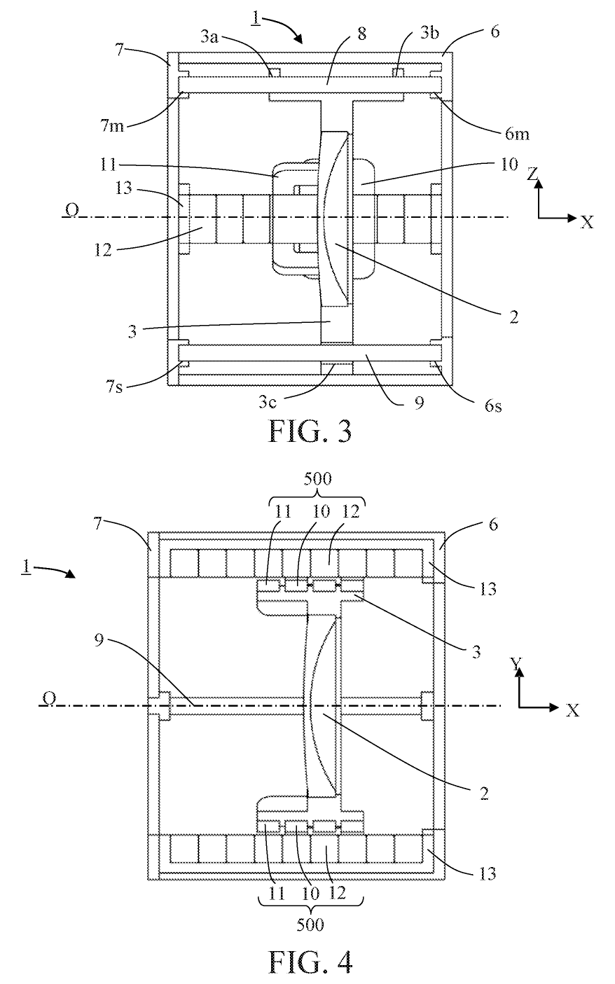

FIG. 2 is an exploded perspective view of the focus unit 1. In the present embodiment, as illustrated in FIG. 2, an optical axis O is defined as an X-axis, and axes orthogonal to the X-axis are defined as a Y-axis and a Z-axis. FIG. 3 is a cross-sectional view of the focus unit 1 cut along an X-Z plane when viewed from a negative Y-axis direction. FIG. 4 is a cross-sectional view of the focus unit 1 cut along an X-Y plane when viewed from a positive Z-axis direction.

A focus lens 2 is formed of a single glass element and constitutes an optical system for focusing. The focus lens 2 may include a plurality of glass elements. Alternatively, the focus lens 2 may be formed of a resin plastic lens.

A lens barrel 3 is formed of a resin material or a metal material. The focus lens 2 is adhesively fixed to the lens barrel 3. The lens 2 and the lens barrel 3 form a movable member. The lens barrel 3 is formed with round holes 3a and 3b through which a main guide shaft 8 is inserted, and a slot 3c through which a sub guide shaft 9 is inserted.

A position detection scale 4 is a strip-shaped reflective scale having a reflection pattern formed on its surface, and constitutes an optical position detection encoder together with a sensor head 5. The position detection scale 4 is adhesively fixed to the lens barrel 3.

The sensor head 5 constitutes an optical position detection encoder together with the position detection scale 4 and detects the position of the lens barrel 3 in an X-axis direction (a direction parallel to the optical axis O). The sensor head 5 is fixed to a fixed barrel 6 via a sensor holder (not illustrated). The sensor head 5 is electrically connected to the lens control unit 400 via a flexible printed circuit board (not illustrated). The lens control unit 400 controls the linear motor 500 using position information detected by the sensor head 5. The position of the lens barrel 3 may be detected by other means such as a magnetic position detection encoder including a magnetic sensor (MR sensor) and a magnetic scale.

The fixed barrel 6 is formed of a resin material or a metal material and has a substantially cylindrical shape. The fixed barrel 6 is fixed to a fixed portion (not illustrated) of the interchangeable lens 100. The fixed barrel 6 includes bearing portions 6m and 6s for press-fitting the main guide shaft 8 and the sub guide shaft 9. The bearing portions 6mand 6smay be formed separately from the fixed barrel 6.

A cover member 7 is formed of a resin material or a metal material and has an approximately annular shape. The cover member 7 is fixed to the fixed barrel 6 by screws (not illustrated). The cover member 7 includes bearing portions 7m and 7s for press-fitting the main guide shaft 8 and the sub guide shaft 9. The bearing portions 7m and 7s may be formed separately from the cover member 7.

The main guide shaft 8 and the sub guide shaft 9 are formed of a metal material and have a cylindrical shape. The main guide shaft 8 is press-fitted and fixed to the bearing portion 6m of the fixed barrel 6 and the bearing portion 7m of the cover member 7 so as to be parallel to the optical axis O. The sub guide shaft 9 is press-fitted and fixed to the bearing portion 6s of the fixed barrel 6 and the bearing portion 7s of the cover member 7 so as to be parallel to the optical axis O. The main guide shaft 8 is inserted through the round holes 3a and 3b of the lens barrel 3. The sub guide shaft 9 is inserted through the slot 3c of the lens barrel 3. Due to this configuration, the lens barrel 3 is configured to move linearly along the optical axis O.

The linear motor 500 includes an A-phase coil 10, a B-phase coil 11, and a magnet assembly 12. By supplying the currents to the A-phase coil 10 and the B-phase coil 11, the linear motor 500 generates a driving force for moving the lens barrel 3 linearly along the optical axis O. Two linear motors 500 are disposed at positions opposed to each other by 180 degrees across the optical axis O. The number of linear motors is not limited to two. In a case where N (where N is an integer of two or more) linear motors 500 are provided, they may be equally spaced at intervals of 360/N degrees along a circumferential direction about the optical axis O. To achieve stable driving and a simple configuration, the number of linear motors may be two or more, such as two or three.

The A-phase coil 10 and the B-phase coil 11 are formed by winding a copper wire on its surface a predetermined number of turns to form an approximately rectangular air-core coil, and then bending the coil. The A-phase coil 10 and the B-phase coil 11 are adhesively fixed to the lens barrel 3 and electrically connected to the driving circuit 300 via a flexible printed circuit board (not illustrated). The A-phase coil 10 and the B-phase coil 11 are disposed opposite the magnet assembly 12 with a proper air gap. The A-phase coil 10 and the B-phase coil 11 have surfaces parallel to the optical axis O, and the surfaces parallel to the optical axis O are disposed closer to the optical axis O than the surface of the magnet assembly on which the magnetic flux is concentrated.

The magnet assembly 12 is an assembly of a plurality of magnets arranged in a Halbach array structure. A surface on a side reverse to (opposite to) a side where a magnetic field is concentrated by the Halbach array structure is adhesively fixed to a magnet holding plate 13.

The magnet holding plate 13 is formed of a resin material or a metal material and has an approximately U-shape. The magnet holding plate 13 is fixed to the fixed barrel 6 by screws (not illustrated). The shape of the magnet holding plate 13 may be a simple flat plate or a box shape with one open surface. Forming the magnet holding plate 13 of a magnetic material can improve the driving force of the linear motor 500. The magnet assembly 12 may be directly fixed to the fixed barrel 6 without providing the magnet holding plate 13.

### SHAPE AND ARRANGEMENT OF COILS

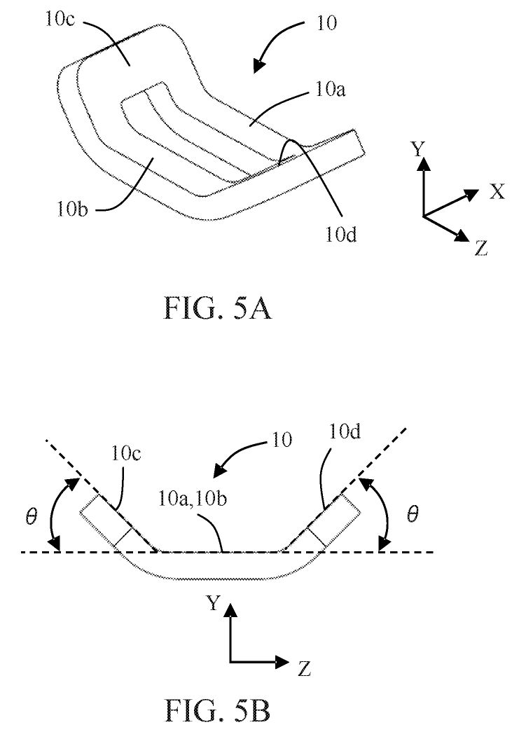

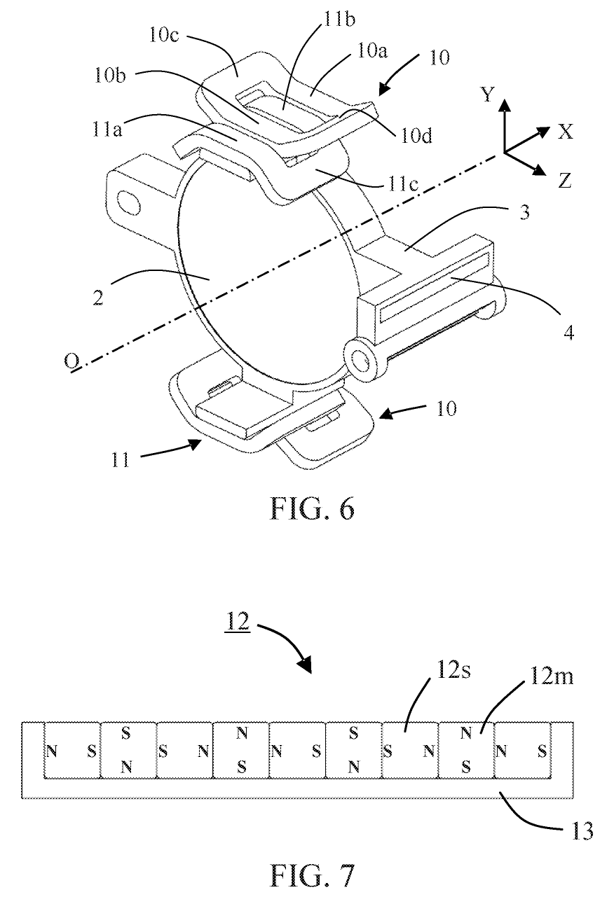

A description will be given of the shape of the A-phase coil 10 and the arrangement of the A-phase coil 10 and the B-phase coil 11. FIG. 5A is a perspective view of the A-phase coil 10. FIG. 5B is a front view of the A-phase coil 10 when viewed from an X-axis direction. FIG. 6 is a perspective view of the lens barrel 3 and peripheral components held by the lens barrel 3.

The A-phase coil 10 includes driving-force generating sides 10aand 10b extending parallel to the Z-axis. The A-phase coil 10 further includes connection sides 10cand 10d that are parallel to the X-axis and generate approximately no driving force. The A-phase coil 10 is a bent coil. More specifically, as illustrated in FIG. 5B, an angle θ formed between a plane contacting the driving-force generating sides 10a and 10b and a plane contacting the connection side 10c or 10d is greater than 0 degrees and less than 90 degrees. In other words, the plane contacting the driving-force generating sides 10a and 10b intersects the plane contacting the connection side 10c or 10d. That is, the A-phase coil 10 includes a plane parallel to the optical axis O (i.e. parallel to both the optical axis O (X-axis) and the Z-axis) and a plane tilted relative to the parallel plane (i.e. parallel to the optical axis O (X-axis) and tilted relative to the Z-axis). Since the B-phase coil 11 has the same shape as that of the A-phase coil 10, a description thereof will be omitted.

The driving-force generating side 10b of the A-phase coil 10 is inserted into an air-core portion of the B-phase coil 11. A driving-force generating side 11b of the B-phase coil 11 is inserted into an air-core portion of the A-phase coil 10. Thus, the driving-force generating sides 10a and 10b of the A-phase coil 10 and the driving-force generating sides 11a and 11b of the B-phase coil 11 are alternately arranged along the X-axis direction. Due to this arrangement, the interchangeable lens 100 can be reduced in size in the X-axis direction. Further, by bending the A-phase coil 10 and the B-phase coil 11, the two coils can be arranged such that the connection side 10c of the A-phase coil 10 and a connection side 11d of the B-phase coil 11, and the connection side 10d of the A-phase coil 10 and a connection side 11c of the B-phase coil 11, do not interfere with each other.

### CONFIGURATION OF MAGNETIC ASSEMBLY

FIG. 7 is a side view of the magnet assembly 12 and the magnet holding plate 13. “N” and “S” indicate magnetic poles of the magnets.

The magnet assembly 12 is formed by adhesively bonding a plurality of main magnets 12m and sub magnets 12s. The main magnets 12mand the sub magnets 12sare alternately arranged along a driving direction. The main magnets 12mand the sub magnets 12sare the same magnets and are arranged with different magnetization directions to form a Halbach array structure. The main magnets 12mand the sub magnets 12sare not necessarily required to have the same shapes. The numbers of the main magnets 12mand the sub magnets 12s are not limited as long as the Halbach array structure is formed.

The main magnets 12m and the sub magnets 12s are formed by sintering a magnetic material including a rare earth element and have an approximately rectangular parallelepiped shape.

### DRIVING METHOD AND OPERATION OF LINEAR MOTOR

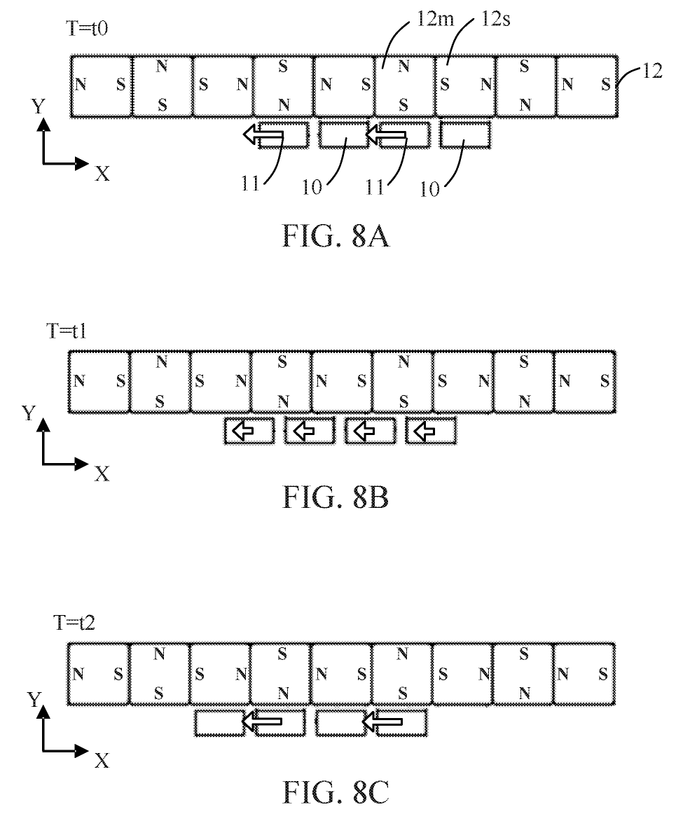

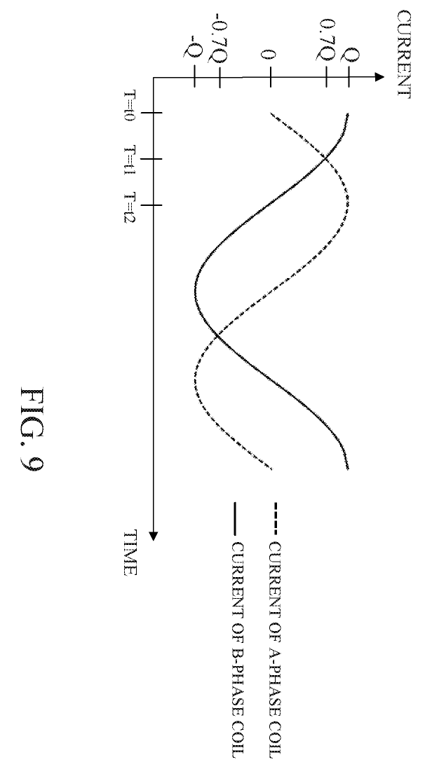

A basic driving method and operation of the linear motor 500 will be described. FIGS. 8A to 8C are X-Y cross-sectional views of the linear motor 500 at times T=t0, t1, and t2, respectively. FIG. 9 is a diagram illustrating temporal changes of the currents supplied to the A-phase coil 10 and the B-phase coil 11.

At time T=t0, the A-phase coil 10 is at a phase of the sub magnet 12s, and the B-phase coil 11 is at a phase of the main magnet 12m. At this time, the current of the A-phase coil 10 is set to 0, and the current of the B-phase coil 11 is set to a predetermined value Q. As a result, a driving force in a negative X-axis direction (arrow in the drawing) is generated in the B-phase coil 11, and the lens barrel 3 moves in the negative X-axis direction.

At time T=t1, the A-phase coil 10 and the B-phase coil 11 are at intermediate phases between the main magnet 12m and the sub magnet 12s. At this time, the current of the A-phase coil 10 is set to approximately 0.7Q, and the current of the B-phase coil 11 is set to approximately 0.7Q. As a result, the driving forces in the negative X-axis direction are generated in both the A-phase coil 10 and the B-phase coil 11, and the lens barrel 3 moves in the negative X-axis direction.

At time T=t2, the A-phase coil 10 is at a phase of the main magnet 12m, and the B-phase coil 11 is at a phase of the sub magnet 12s. At this time, the current of the A-phase coil 10 is set to Q, and the current of the B-phase coil 11 is set to 0. As a result, the driving force in the negative X-axis direction is generated in the A-phase coil 10, and the lens barrel 3 moves in the negative X-axis direction.

The direction of the current supplied to each coil may be set such that a Lorentz force from the magnets acts in the negative X-axis direction. When driving in the positive X-axis direction, the current may be set such that a Lorentz force from the magnets acts in the positive X-axis direction.

Supplying currents to the A-phase coil 10 and the B-phase coil 11 as described above can make the driving force for moving the lens barrel 3 constant.

In the actual control of the interchangeable lens 100, more complex position feedback control and velocity feedback control are performed using the above basic driving method, but a detailed description thereof will be omitted since it is not essential to the present disclosure.

### OPERATION

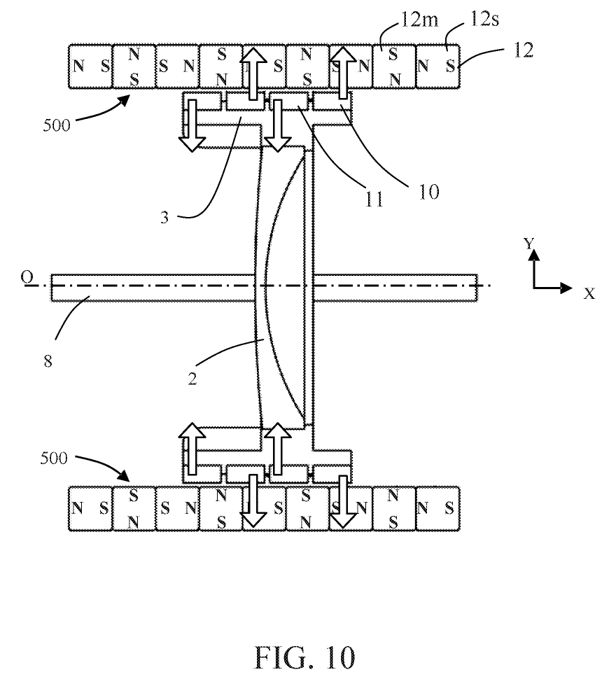

The operation of the present disclosure will be described with reference to FIG. 10. FIG. 10 is an X-Y cross-sectional view illustrating main components of the focus unit 1 at time T=t1 in FIG. 9.

In the linear motor 500, the magnetic flux in the driving direction generated by the sub magnet 12s and the currents (paper plane direction) flowing through the A-phase coil 10 and the B-phase coil 11 generate the Lorentz force in the direction orthogonal to the optical axis O (arrow direction).

In the present embodiment, two linear motors 500 are disposed at positions opposed to each other by 180 degrees across the optical axis O. Therefore, the Lorentz forces in the direction orthogonal to the optical axis O generated by the magnetic flux of the sub magnets 12s are generated symmetrically with respect to the optical axis O between the upper linear motor 500 and the lower linear motor 500 in the drawing. As a result, the Lorentz forces in the direction orthogonal to the optical axis O cancel each other.

Therefore, no moment acts on the lens barrel 3, and tilting of the lens barrel 3 can be suppressed. As a result, the degradation of the optical performance of the interchangeable lens 100 can be suppressed. Further, since the periodically generated Lorentz forces also cancel out, the vibration noise of the lens barrel 3 can be suppressed. As a result, the degradation of the moving image capturing performance can be suppressed.

### SECOND EMBODIMENT

In the present embodiment, an A-phase coil 110 and the B-phase coil 11 have different shapes. More specifically, unlike the first embodiment, the A-phase coil 110 has a shape different from that in the first embodiment. More specifically, the B-phase coil 11 has a shape (second shape) including a bent portion as in the first embodiment, while the A-phase coil 110 has a shape (first shape) having no bent portion. Other components and arrangements are the same as those of the first embodiment, and a description thereof will be omitted.

### CONFIGURATION OF FOCUS UNIT

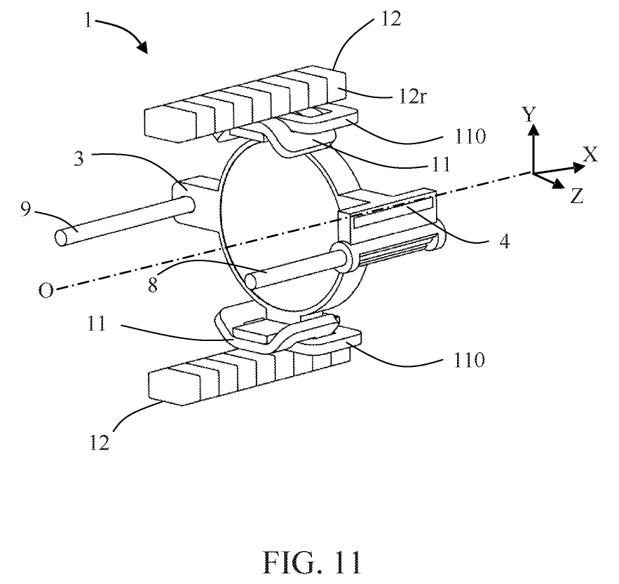

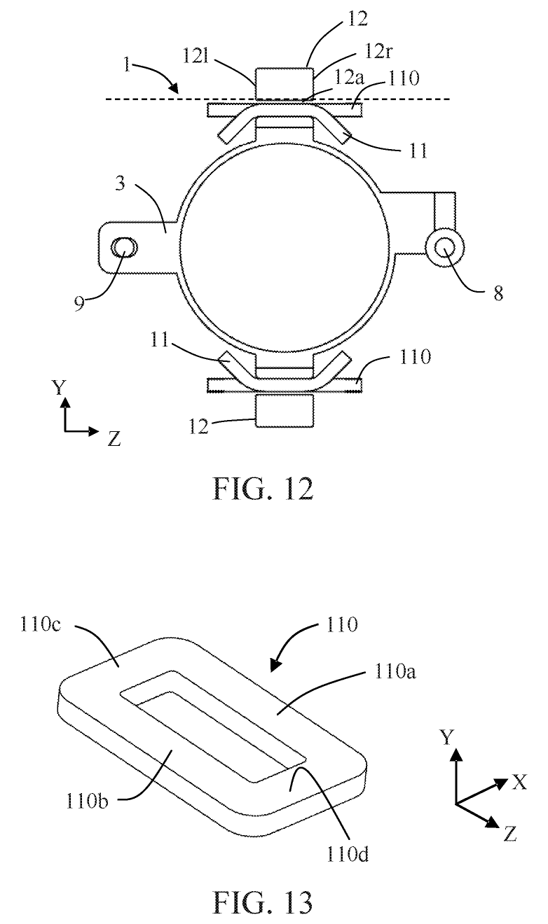

FIG. 11 is a perspective view illustrating only some components of the focus unit 1 according to the present embodiment. FIG. 12 is a front view of the focus unit 1 according to the present embodiment when viewed from the negative X-axis direction. FIG. 13 is a perspective view of the A-phase coil 110 according to the present embodiment.

Unlike the A-phase coil 10 according to the first embodiment, the A-phase coil 110 is a flat coil having no bent portion. That is, in the A-phase coil 110, an angle θ formed between a plane contacting driving-force generating sides 110a and 110b and a plane contacting a connection side 110c or 110d is 0 degrees. In other words, the plane contacting the driving-force generating sides 110a and 110b does not intersect the plane contacting the connection side 110c or 110d. As a result, the A-phase coil 110 is disposed so as not to intersect a plane including a surface 12a on which the magnetic flux of the magnet assembly 12 is concentrated (on the side closer to the optical axis O than the surface 12a on which magnetic flux of the magnet assembly 12 is concentrated). Since the B-phase coil 11 has a bent portion, the A-phase coil 110 and the B-phase coil 11 can be arranged without interference. The B-phase coil 11 is also disposed so as not to intersect the plane including the surface 12a on which the magnetic flux of the magnet assembly 12 is concentrated (on the side closer to the optical axis O than the surface 12a).

### OPERATION

A reason for configuring the A-phase coil 110 as described above will be described. Magnetic fields are generated to some extent on side surfaces 12r and 12l (surfaces orthogonal to the Z-axis) of the magnet assembly 12 having a Halbach array. Therefore, when current flows through the connection sides 10c and 10d of the A-phase coil 10 in the first embodiment, the Lorentz force is generated by the magnetic fields of the side surfaces 12r and 12l. On the other hand, since the B-phase coil 11 is located farther from the side surfaces 12r and 12l, the Lorentz force due to magnetic fields of the side surfaces 12r and 12l is hardly generated in the B-phase coil 11. As a result, a difference occurs between the driving force generated by the A-phase coil 10 and the driving force generated by the B-phase coil 11.

In the present embodiment, by placing the A-phase coil 110 away from the side surfaces 12r and 12l, the A-phase coil 110 is hardly affected by the magnetic fields of the side surfaces 12r and 12l. That is, the Lorentz force generated by magnetic fields of the side surfaces 12r and 12lin the A-phase coil 110 can be reduced. Therefore, the driving forces of the A-phase coil 110 and the B-phase coil 11 can be made approximately equal, and the interchangeable lens 100 can be controlled stably.

Each embodiment can provide a lens driving apparatus that has a reduced size and can suppress the deteriorations of the optical performance and moving image capturing performance.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

For example, in the present embodiment, the movable member is a lens and a lens barrel. However, the movable member may not include a lens and may be another optical element, such as a mirror, a prism, a plate (e.g., a cover glass), and an optical filter. In addition, the movable member may be a member other than the optical element.

What is claimed is:

1. An optical apparatus comprising:
a movable member; and
two or more motors each including a first coil, a second coil, and a magnet assembly,
wherein each of the first coil and the second coil is configured to generate a driving force to the movable member in a direction parallel to an optical axis,
wherein the magnet assembly has a Halbach array,
wherein at least one of the first coil and the second coil includes a bent portion, and
wherein, when a number of the motors is N, the two or more motors are arranged at intervals of 360/N degrees along a circumferential direction about the optical axis.

2. The optical apparatus according to claim 1, wherein the first coil and the second coil have different shapes from each other.

3. The optical apparatus according to claim 1, wherein the first coil has no bent portion, and
wherein the second coil has the bent portion.

4. The optical apparatus according to claim 3, wherein the first coil and the second coil are disposed closer to the optical axis than a surface of the magnet assembly on which a magnetic flux is concentrated.

5. The optical apparatus according to claim 1, wherein at least one of the first coil and the second coil includes a plane parallel to the optical axis and a plane tilted relative to the plane parallel to the optical axis.

6. The optical apparatus according to claim 1, wherein each of the first coil and the second coil includes a plane parallel to the optical axis, and
wherein the plane parallel to the optical axis is located closer to the optical axis than a surface of the magnet assembly on which magnetic flux is concentrated.

7. The optical apparatus according to claim 1, wherein the number of the motors is two.

8. The optical apparatus according to claim 1, wherein the number of the motors is three.

9. The optical apparatus according to claim 1, wherein the optical apparatus is detachably attachable to an image pickup apparatus.

10. An image pickup system comprising:
the optical apparatus according to claim 1; and
an image pickup apparatus.
